(19) United States
(12) Patent Application Publication
(10) Pub. No.: US 2012/0189977 A1
(43) Pub. Date: Jul. 26, 2012

(54) Applicator for a dental liquid

(75) Inventors: Lutz Vocke, Bad Homburg (DE); Jan Ziegler, Geislingen/Steige (DE)

(73) Assignee: HERAEUS KULZER GMBH, Hanau (DE)

(21) Appl. No.: 13/352,848

(22) Filed: Jan. 18, 2012

(30) Foreign Application Priority Data
Jan. 21, 2011 (DE) 10 2011 009 187.4

(51) Int. Cl. A61C 17/02

(52) U.S. Cl. 433/90

(57) ABSTRACT

An applicator for a one-handed operation for storing and applying a dental liquid, including a container for the dental liquid and a tubing for guiding the dental liquid from the container to an applicator tip. The container is made of foil, which can be punctured by a mandrel. The dental liquid is expelled through a displacement plunger, whereby puncturing and expelling are effected through actuating a handle and the container is positioned with respect to the mandrel in suitable manner such that the advancing mechanism that is used to expel the dental liquid from the applicator is also used to puncture or slit open the foil with the mandrel, whereby the container is opened through the same force that is used to dispense the dental liquid and one-handed operability of the applicator is attained not only when the dental liquid is dispensed, but also when the container is being opened.

### BACKGROUND OF THE INVENTION

(1) Field of the Invention

The invention relates to applicators for one-handed operation for storing and applying a dental liquid, comprising a container containing the dental liquid and a tubing that can be used to guide the dental liquid from the container to a surface of an applicator tip of the applicator.

The invention also relates to a method for applying a dental liquid using an applicator of said type.

(2) Description of Related Art

Applicators for applying a dental liquid are known according to the prior art. In dentistry, they are used to apply dental liquids inside the oral space of a patient. In order to also render accessible those regions inside the oral space that are difficult to access, some of said applicators, such as, for example, the ones known from US 2003/0013066 A1 or US 2002/0090591 A1, comprise an angled applicator tip.

It is known from US 2003/0013066 A1 and U.S. Pat. No. 6,059,570 A to use an applicator with a freely mobile feed plunger to expel the content.

An applicator is known from US 2004/0197730 A1, in which the fluid to be applied is stored in a break-off ampoule on the handle of the applicator. The ampoule is to be broken off and is thus opened. Structured like a paint brush, the applicator tip can subsequently be immersed into the opened ampoule in order to wet the applicator tip with dental liquid. The wetted applicator tip can subsequently be used to apply the dental liquid.

This is disadvantageous in that the applicator needs to be operated with both hands and is laborious to operate even if it is immersed repeatedly.

An applicator that can be operated by one hand is known from US 2009/0060624 A1. Said applicator is equipped with an advancing mechanism with a complex design that advances a replacement plunger that is used to expel the dental liquid from the applicator. The applicator tip and the advancing mechanism are covered by a cap in order to prevent inadvertent leakage of dental liquid from the applicator. Dental liquids can contain chemically aggressive substances that should not leak from the applicator inadvertently.

An applicator of said type is disadvantageous despite being easier to operate, since there is still a need to loosen the caps in order to render the applicator ready for use. Moreover, the caps may loosen inadvertently and dental liquid may accumulate in the cap over the applicator and then leak when the cap is opened. Moreover, the container of the applicator may become leaky due to the chemical aggressiveness of the dental liquid.

Accordingly, it is the object of the invention to overcome the disadvantages of the prior art. In particular, the operation of the applicator is to be made as easy and uncomplicated as possible such that it interferes as little as possible with the steps that go on during treatment. Moreover, easy handling is to be attained through the structure being as uncomplicated and simple as possible. Simultaneously, the applicator should provide a container for the dental liquid that is as safe as possible in order to prevent the surroundings from being contaminated.

### BRIEF SUMMARY OF THE INVENTION

The object of the invention is met by a device according to claim 1.

In the present context, a dental liquid is understood to mean a liquid, suspension or a mixture comprising a liquid that is sufficiently fluid to allow the dental liquid to be applied. In this context, the pressure applied by one hand in the manner of a syringe may be sufficient to push the dental liquid through the tubing to the surface of the applicator tip and, if applicable, through a manifold. Typical dental liquids are, for example, bleaching agents, adhesives, filling materials, disinfection agents, and coatings.

Until the container in the applicator is opened, the foil seals the container and prevents the dental liquid from leaking and thus prevents contamination of the surroundings and any loss of dental liquid. According to the invention, the thickness of the foil can be substantial provided it can still be punctured mechanically through a manual pressure.

The invention can provide the foil to be an aluminum multi-composite foil. The foil can be welded to an open-sided container edge through a thermal sealing procedure or welding procedure.

The coating also effects sealing of the container. Coating generates an additional barrier for the dental liquid and thus also prevents contamination of the surroundings by the dental liquid or components thereof. For this purpose, the coating can be adapted to the ingredients of the dental liquid.

The invention can also provide the applicator to comprise at least one further container with at least one further component of a dental liquid, whereby a mixed dental liquid is obtained through mixing the two container contents. This can be advantageous if the two components of the mixed dental liquid react with each other and should therefore be mixed with each other only shortly before application or use in the patient.

The invention provides a mandrel to be arranged in the applicator that can be used to puncture the foil, whereby the container with punctured foil is opened and whereby the mandrel preferably is arranged in the region of the tubing and of the container, particularly preferably is provided as a hollow mandrel that forms a first end of the tubing. Instead of a mandrel, a blade may be provided that is used to cut the foil open.

This is advantageous in that the foil of the container can be pressed onto the mandrel in order to open the container and thus render the applicator ready for use. This allows to dispense with having an additional cap covering the applicator tip. The container is positioned with respect to the mandrel in suitable manner such that the advancing mechanism that is used to expel the dental liquid from the applicator is also used to puncture or slit open the foil with the mandrel. Then, the opening of the container is opened through the same force that is used to dispense the dental liquid. Thus the applicator can be operated by one hand not only during dispensation of the dental liquid, but also while the container is opened and the applicator rendered ready for use.

Moreover, in the case of coated containers, the invention can provide that the coating is a hydrophobic and/or chemically resistant coating that is preferable temperature-resistant up to more than 200° C.

Moreover, the invention can provide the coating for coated containers to be a non-porous polymer coating, preferably a parylene coating.

A non-porous polymer coating of said type is particularly well-suited for dental liquids owing to its chemical inertness. In this context, the absence of pores prevents the dental liquid or components thereof from percolating through to the actual container wall. It is feasible to use a material for the coating that has insufficient mechanical stability for the container wall or would be too expensive. Poly(para-xylylene), or parylene for short, can be applied, for example, through CVD (chemical vapour deposition) as a layer with layer thicknesses being between several 100 nm to several 10 μm. The parylene coating is particularly well-suited, in particular, for dental liquids, owing to its chemical inertness. Moreover, the chemical inertness and mechanical stability of parylene during the manufacture and use of the applicator is advantageous. Another particular advantage is the abrasion resistance of the parylene coating and the ability to apply parylene coatings at low temperatures.

Since the solvents that are customarily used for dental liquids are volatile, it is reasonable to provide a product-adapted barrier effect. Since the bulk plastic materials available in the market, as the pure product, do not achieve a sufficient barrier effect, the container must be provided with an additional feature through additional processing procedures. The barrier effect with respect to solvents of this type through the so-called parylene coating is improved. This has been observed experimentally through storage tests and tests of losses of mass of a test medium.

The invention can provide the thickness of the coating to be 0.1 μm to 100 μm, preferably between 1 μm and 10 μm.

The invention can also provide the tubing to be flexible and to comprise a channel for transit of the dental liquid from the container, whereby the channel is connected on one side to the container through a fluid communication.

Owing to the flexibility of the tubing, the applicator can be adapted to the accessibility of the site in the oral space that is to be treated.

An applicator, which is particular well-suited for use during a treatment scenario, results from providing the applicator to comprise a manifold for distribution of the dental liquid, in particular at a second end of the tubing at the applicator tip, whereby the manifold forms the surface of the applicator tip.

In this context, the invention can provide the manifold to comprise an open-pored material or to consist of an open-pored material.

The invention can also provide the open-pored material to be a sponge and/or foam material, preferably the manifold to be a punched out piece of foam material.

The invention can also provide the pore size of the open-pored material to be from 50 nm to 500 μm, preferably from 0.5 μm to 100 μm, particularly preferably from 5 μm to 50 μm.

Moreover, the invention can provide the manifold to be exchangeable and/or replaceable, preferably can be plugged onto the first end of the tubing. This measure results in an applicator for variable uses.

Moreover, the invention can provide the manifold to comprise a multitude of channels that are connected to the channel of the tubing through fluid communications.

According to another refinement of the invention, the flexible tubing can be bent by at least 45°, preferably by at least 90°, particularly preferably by at least 100°.

A refinement of the invention provides that the flexible tubing can be deformed plastically.

Particularly preferred embodiments of the invention can provide the dental liquid to contain water, acetone, ethanol, isopropanol, ethyl acetate, MMA and/or tert. butanone.

A particularly well-sealed embodiment of an applicator according to the invention can be attained through providing the container to be double-walled, whereby the inner wall, at least regions thereof, preferably is made from a highly dense plastic material and/or the outer wall is made from a cyclo-olefine copolymer (COC).

Moreover, the invention can provide the applicator to comprise a displacement plunger for expelling the dental liquid from the container.

In this context, the invention can provide the applicator to comprise a lock-in mechanism that can be used to fix the displacement plunger in place with respect to the container.

Moreover, the invention can provide the lock-in mechanism to have a plurality of lock-in steps, whereby the lock-in steps can be overcome manually such that portions of the dental liquid can be applied from the container.

The lock-in mechanism enables haptic and tangible portioning of the dental liquid upon manual operation of the applicator. Moreover, the lock-in position, in which the displacement plunger is situated, allows reading how much of the dental liquid is still present in the applicator.

Moreover, the invention can provide the applicator to comprise a volume displacer for complete emptying of the container.

The volume displacer can be arranged on the displacement plunger. Its purpose is to squeeze even the last residues of dental liquid from the applicator and thus render the entire internal volume of the container available for use. For this purpose, the volume displacer can be adapted to the internal shape of the container in the region of the tubing and also to the tubing or, as it may be, the channel.

According to the invention, the tubing or the channel of the tubing, as it may be, including regions thereof, can be filled with the fluid such that the channel or the tubing, as it may be, is also a part of the container. Accordingly, the channel of the tubing does not necessarily have to be empty.

The object of the invention is also met by a method for applying a dental liquid with an applicator according to claim 1, in which a foil and/or the container is opened, in particular is punctured, before applying the dental liquid.

In this context, the invention can provide the applicator tip, in particular a manifold of the applicator, to be wiped over the surface to be coated by dental liquid and a pressure to be applied concurrently onto the dental liquid on the inside of the container such that the dental liquid is applied through the flexible tubing and the applicator tip, in particular the manifold.

In this context, the invention again provides the pressure to be applied to the dental liquid through a displacement plunger.

A refinement, according to the invention, of the method can provide the displacement of the dental liquid through the pressure to lead to at least wetting of regions of the surface of the applicator tip, in particular of the manifold.

The invention can also provide the filling level of the container to be determined by haptic and/or acoustic means through the use of a lock-in mechanism.

It is particularly advantageous for the dental liquid to be applied by one hand.

And lastly, the invention can provide a manifold that is suitable for the surface to be wetted to be attached on the applicator tip before applying the dental liquid to the surface to be wetted.

The invention is based on the surprising finding that the coating and the foil, including each alone, allow the sealing of the applicator to be improved, whereby the same hand operation needed to use the applicator also renders the applicator ready for use. The coating is a simple option of sealing the container with respect to the dental liquid better and in a more sustained manner such that the dental liquid cannot exit from the container as easily. In this context, the foil, which also serves to seal the container, allows the container to be opened easily in that it gets opened mechanically. For this purpose, it is sufficient to slit or perforate the foil. The foil could be punched just as well. The same force that is used to expel the dental liquid can be used for this purpose. Accordingly, for example the container can be pressed onto a mandrel until the foil yields by exerting a pressure onto a displacement plunger.

Especially the combination of foil and coating enables a suitable container for an applicator to be designed, which utilises the mechanical stability of a material for the container wall and/or the foil and, concurrently, the chemical inertness of a second material of the coating with respect to the dental liquid. The combination therefore enables the design of particularly thin container walls and/or foils.

The present invention therefore provides a multi-part plastic container for direct application of dental liquids to surfaces in the region of the oral cavity, or, as it may be, a packaging system for so-called single-use (also called “single dosage” or “single usage”). It enables the user to provide rapid, easy-to-handle and safe management to the patients.

The dental liquid to be applied is situated in the container that is closed through a foil. Applying a pressure to the container, in particular the rear side of the container, activates the packaging system to be ready for use. For this purpose, the foil is punctured through a mandrel-like counter-part on the inside of the applicator tip or on the inside of the applicator.

An acetone-containing liquid that is relevant for the dental application (“dental bonding”) is made ready separately in the corresponding container. The dental liquid is thereby separated spatially from the applicator tip. Both parts are plugged into each other in the inactive state as well (condition at the time of delivery).

After activation, the stored dental liquid is transported through a channel, which is designed to be the inside, to the application tip to be wetted. The activation process is triggered through a specially shaped plastic cylinder on the inside of the applicator. The arrangement and shape of the cylinder includes a mandrel or a blade that can be used as an aid to puncture or cut open the foil. For optimal opening behaviour, the dimensions of the mandrel or blade and the dimensions of the inside of the container are made to match each other. The liquid transport from the container in the direction of the application tip proceeds through volume displacement of the interior space of the container.

Connecting the applicator and the reservoir container enables operation by one hand. The displacement of the internal volume leads to wetting of the applicator tip. A double chamber can be provided in order to optimise the barrier effect of the plastic material with respect to the sensitive and aggressive acetone mixture.

Applicators and methods according to the invention enable one-handed activation, time-saving application and reduction of the preparation time.

### BRIEF DESCRIPTION OF THE SEVERAL VIEWS OF THE DRAWING(S)

Exemplary embodiments of the invention shall be illustrated in the following on the basis of three schematic figures, though without limiting the scope of the invention. In the figures:

FIG. 1: shows a schematic cross-sectional view of an applicator according to the invention;

FIG. 2: shows a schematic cross-sectional view of a different applicator according to the invention; and

FIG. 3: shows a schematic side view of the applicator according to FIG. 2.

### DETAILED DESCRIPTION OF THE INVENTION

FIG. 1 shows a schematic cross-sectional view of an applicator 1 according to the invention that contains a dental liquid 2. The dental liquid 2 is situated in a container 3 that has a cylindrical interior space. A cylindrical displacement plunger 4 is arranged in the container 3 at one end of the applicator 1. The displacement plunger 4 is arranged in the container 3 such as to be mobile along the cylinder axis and can be advanced through a rod 6 that is attached in fixed manner to the displacement plunger 4.

A flexible tubing 8 is arranged on the front side of the applicator 1 and comprises a channel 11 that connects the inside of the container 3 to an applicator tip 10. The shape of the displacement plunger 4 on its front side is adapted to the shape of the container 3 in the region of the transition into the tubing 8. Said shape is a volume displacer that ensures that all of the dental liquid 2 can be expelled from the inside of the container 3 through the displacement plunger 4.

The channel 11 of the tubing 8 exits in the region of the applicator tip 10 into a manifold 12 that is made of a porous, open-pored foam material. Additional channels 14 are provided in the manifold 12 and are meant to support the distribution of the dental liquid 2 on the surface of the manifold 12 upon application of the applicator 1. The manifold 12 can be inserted into the applicator tip 10 and replaced by hand.

The dental liquid 2 is enclosed in the applicator 1 through a flexible foil 16. The foil 16 forms the internal wall of the container 3. A mandrel 18 that can be used to slit open the foil 16 is arranged in the region of entry of the channel 11 of the tubing 8 into the interior space of the container 3. Exerting a pressure onto the displacement plunger 4 causes the dental liquid 2 including foil 16 to be pressed onto the hollow mandrel 18 and the foil 16 to be thus opened.

Pressing even more onto the displacement plunger 4 pushes the dental liquid 2 from the container 3 through the channel 11 into the manifold 12. In this place, the dental liquid 2 soaks the manifold 12 and finally exits to the surface of the manifold 12. The surface of the manifold 12 that is wetted by the dental liquid 2 is then wiped over the surface in the oral space of a patient that is to be wetted. The dental liquid 2 is thus transferred to the surface to be treated. Any uneven pressure being applied to the displacement plunger 4 is balanced out by the absorption capacity of the porous manifold 12.

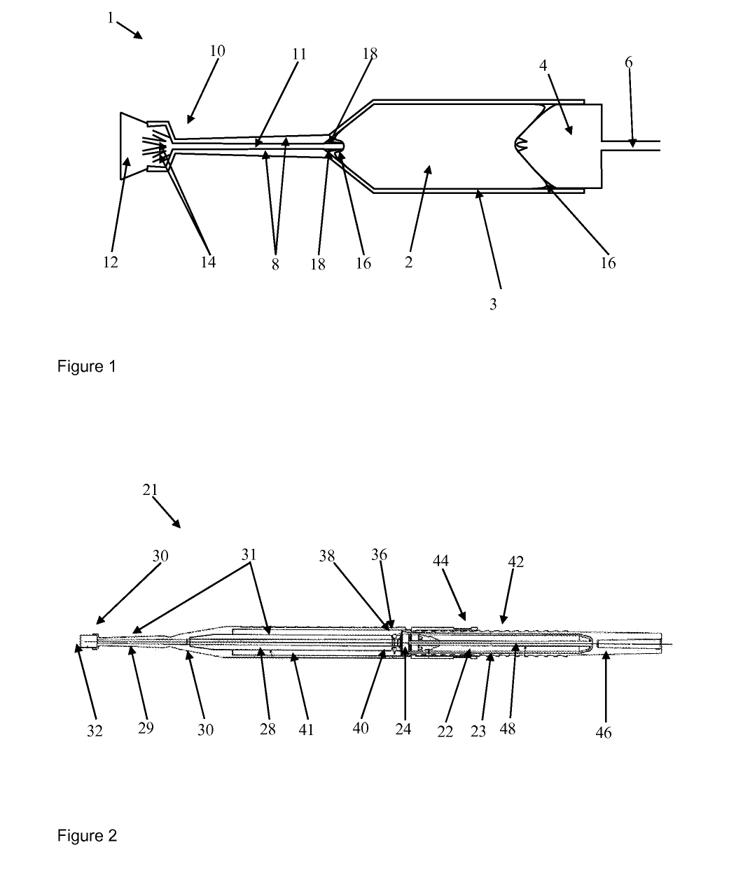

FIG. 2 shows a schematic cross-sectional view of an applicator 21 according to the invention. In this embodiment, a dental liquid 22 is contained in a coated container 23. A displacement plunger 24 is arranged in the container 23 at one end of the container 23 and can be slid against the container 23.

The container 23 can also be slid against a tubing 28. The displacement plunger 24 can therefore be connected to the tubing 28 or the tubing 28 is structured such that the walls of the container 23, but not the displacement plunger 24, can be moved against the tubing 28. The entire tubing 28, 29 comprises a flexible tubing 29 in the region of an applicator tip 30. A channel 31 is arranged in the two parts of the tubing 28, 29 and connects the inside of the container 23 to the applicator tip 30 or, as it may be, to a manifold 32 arranged on it. The manifold 32 is a punched-out piece of foam material that is inserted into an opening on the external end of the flexible tubing 29.

The container is closed through a foil 36 on the end of the container 23 facing the tubing 28. The foil 36 rests on mandrels 38 that are capable of opening the foil 36 and thus the container 23. A seal 40 is arranged on the entry of the tubing 28 into the container 23 and prevents the dental liquid 22 from penetrating into a hollow space 41 that takes up the side walls of the container 23 while the container is being slid over the tubing 28. During the insertion of the side walls of the container 23 into the hollow space 41, the displacement plunger 24 remains in the same position with respect to the tubing 28 such that the dental liquid 22 is pushed from the inside of the container 23 through the tubing 28, 29 into the manifold 32. The dental liquid 22 advances through the open-pored manifold 32 to the surface of the manifold 32. In this place, it can be dispensed to the site to be treated or, as it may be, it can be applied to the site to be treated.

The internal surfaces of the container 23 and, preferably, the surface of the foil 36 facing the inside of the container 23 are coated with parylene in order to prevent the container walls and the foil 36 from being dissolved by the chemically aggressive dental liquid 22. The dental liquid 22 can contain, for example, acetone, ethyl acetate, MMA and/or tert. butanone. These chemically aggressive substances can dissolve the polymers of which the container 23 and other parts of the applicator 21 are made. As a result, the container 23 might become porous and dental liquid 22 might leak out. This is prevented through the parylene coating. The foil 36 can be a thin uncoated metal foil that is resistant to the substances contained in the dental liquid.

Parylene coatings are extremely thin, non-porous polymer coatings that are used for a broad range of purposes. Parylene is an inert, hydrophobic, optically transparent, biocompatible, polymeric coating material with a broad range of industrial applications.

The parylene coating is applied in vacuo to the substrate material (container walls, internal and external) through condensation from the gas phase as a non-porous and transparent polymer film. Owing to being deposited as a gas, parylene reaches and coats even regions and structures that cannot be coated through liquid-based methods, such as, for example, sharp edges and tips or narrow and deep gaps. Coatings between 0.2 and 100 μm in thickness can be applied in a single working step.

A lock-in mechanism 42 is arranged on the external surface of the container 23 and engages a counter-lock-in mechanism 44 that is firmly connected to the tubing 28. A handle 46 is arranged on the end of the applicator 21 that is opposite from the dispensing tip 30 and can be used to push the container 23 into the hollow space 41. A volume displacer 48 is arranged on the inside of the container 23 and slides into the tubing 28. The volume displacer 48 is a cylindrical tube with an external diameter that is somewhat larger than the internal diameter of the tubing 28. The difference of the diameters ensures that the dental liquid 22 is pushed through the tubing 28 even when the volume displacer 48 is slid in. The volume displacer 48 being slid-in reduces the effective cross-section of the tubing 28. This reduces the dead volume of the applicator 21. Accordingly, less dental liquid 22 remains unused in the applicator 21.

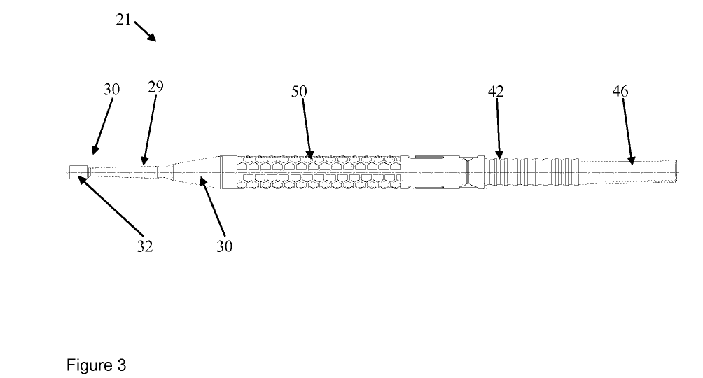

FIG. 3 shows a schematic side view of the applicator 21 according to FIG. 2. The elastic manifold 32 is attached to the flexible tubing 29. The lock-in mechanism 42 can be seen in the region of the container 23. The handle 46 can be used to slide the container 23 into the hollow space 41, whereby the lock-in mechanism 42 engages the counter-lock-in mechanism 44.

A profile 50, in the form of a honeycomb structure, is provided on the applicator 21 in the region of the hollow space 41. Said structure allows material to be saved at the same mechanical stability.

The system of the applicator 21 consists of multiple individual components most of which can be manufactured through an injection moulding method. It is particularly advantageous for the applicator 21 to comprise the following components for this purpose: an applicator tip 30 including a punched-out piece of foam material 32 and a tubing 28, a displacement plunger 24 and a container part 23 comprising a two-part cartridge (external and internal cartridge) that is closed through a sealing foil 36.

The applicator tip 30 consists not only of a designed injection moulding part, but also of a specially shaped punched-out piece of foam material 32. The purpose of the tip, in particular, is surface management in the oral space. The punched-out piece of foam material 32 used here increases the surface of the applicator tip 30 sufficiently such that management of the surfaces to be treated is rendered easier. In addition, uncontrolled ejection of the dental liquid 22 during activation is thus prevented.

It is particularly advantageous in this method that there is no hard plastic core of the type that is flocked with PA filaments in so-called “micro-brush” applicators. This facilitates more gently management of sensitive tooth surfaces.

The present container 23 consists of two individual containers, one placed inside the other, that are being connected to each other in a form-fitting manner. The dental liquid 22 to be stored is taken up by the inner container part that can be made from a commercial bulk plastic material (HDPE) or variants made of BAREX, PEBAX or Surlyn (made by DuPont). The external cartridge shell is made from a COC plastic material in order to attain an additional barrier effect with respect to the (acetone-containing) dental liquid.

The features of the invention disclosed in the preceding description and in the claims, figures, and exemplary embodiments, can be essential for the implementation of the various embodiments of the invention both alone and in any combination.

What is claimed is:

1. An applicator for one-handed operation for storing and applying a dental liquid, comprising
a container containing the dental liquid and a tubing for guiding a dental liquid from the container to a surface of an applicator tip of the applicator,
the container is made at least partially from a foil which closes the container in a fluid-tight manner,
a mandrel is arranged in the applicator for puncturing the foil to open the container and in the region of the tubing and the container ,
the applicator comprises a displacement plunger for expelling the dental liquid from the container, and a handle disposed on the end of the applicator opposite from the applicator tip,
the handle being used for pushing the container into a hollow space formed and which takes up the side walls of the container while the container is being slid over the tubing,
whereby the displacement plunger remains in the same position with respect to the tubing when the side walls of the container are being slid into the hollow space such that the dental liquid is pushed from the inside of the container through the tubing, and
the container is positioned with respect to the mandrel for the advancing mechanism that is used to expel the dental liquid from the applicator, and is also used to puncture or slit open the foil with the mandrel, whereby the container is opened through the same force that is used to dispense the dental liquid, and
one-handed operability of the applicator is attained when the dental liquid is dispensed, and when the container is being opened.

2. The applicator according to claim 1, wherein the container is coated.

3. The applicator according to claim 2, wherein the coating is a non-porous polymer coating.

4. The applicator according to claim 1, wherein the tubing is flexible and comprises a channel for guiding the dental liquid from the container, the channel being connected on one side to the container through a fluid communication.

5. The applicator according to claim 1, wherein the applicator comprises a manifold for distributing the dental liquid, and wherein the manifold forms the surface of the applicator tip.

6. The applicator according to claim 5, wherein the manifold is exchangeable.

7. The applicator according to claim 4, wherein the flexible tubing is bendable by at least 45°.

8. The applicator according to claim 4, wherein the flexible tubing is plastically deformable.

9. The applicator according to claim 1, wherein the dental liquid contains water, acetone, ethanol, isopropanol, ethyl acetate, MMA and/or tert. butanone.

10. The applicator according to claim 1, wherein the container is double-walled.

11. The applicator according to claim 1, wherein the applicator comprises a lock-in mechanism for fixing the displacement plunger in place with respect to the container.

12. The applicator according to claim 11, wherein the lock-in mechanism has a plurality of lock-in steps, wherein the lock-in steps are capable to be overcome manually such that portions of the dental liquid are being applied from the container.

13. The applicator according to claim 5, wherein the manifold is disposed at the second end of the tubing at the applicator tip.

14. The applicator according to claim 3, wherein the non-porous polymer coating is a parylene coating.

15. The applicator according to claim 5, wherein the manifold is connected to the first end of the tubing.

16. The applicator according to claim 4, wherein the flexible tubing is bendable by at least 90°, particularly preferably by at least 100°.

17. The applicator according to claim 4, wherein the flexible tubing is bendable by at least 100°.

18. The applicator according to claim 10, wherein the container is double-walled, whereby the inner wall, at least regions thereof, are made from a highly dense plastic material and the outer wall is made from a cyclo-olefine copolymer (COC).

19. The applicator according to claim 5, wherein the manifold is plugged onto the first end of the tubing.
